(19) United States
(12) Patent Application Publication
(10) Pub. No.: US 2017/0288186 A1
(43) Pub. Date: Oct. 5, 2017

(54) THERMAL RUNAWAY CONTAINMENT APPARATUS FOR A BATTERY

(71) Applicant: CORVUS ENERGY LTD., Richmond (CA)

(72) Inventors: Johannes Christian Kruger, Richmond, BC (CA); Geoffrey Frederick Crocker, Richmond, BC (CA)

(21) Appl. No.: 15/505,551

(22) PCT Filed: Aug. 21, 2015
(86) PCT No.: PCT/CA2015/050802

§ 371 Date: Feb. 21, 2017

Related U.S. Application Data
(60) Provisional application No. 62/040,638, filed on Aug. 22, 2014.

(51) Int. Cl. H01M 2/12; H01M 10/0525; H01M 10/613; H01M 10/65; H01M 2/10; H01M 2/02

(52) U.S. Cl. CPC H01M 2/12; H01M 2/1016; H01M 2/02; H01M 10/613; H01M 10/65; H01M 10/0525

(57) ABSTRACT

A thermal runaway containment apparatus for a battery includes an enclosure base configured to receive a battery therein, an enclosure lid, and a lid constraining structure. The enclosure base has an interconnected floor and side walls, with a top rim defining an open top. The enclosure lid is seatable on the top rim in a seated position that closes the enclosure base. The lid constraining structure is positioned above the lid such that vertical movement of the lid is constrained between the seated position and a maximum partially separated position. When the lid is in the maximum partially separated position, a tortuous flow path into the base is defined; the tortuous flow path allows for venting of pressurized gases out of the enclosure base while impeding inflow of gases at a lower pressure than the pressurized gases into the enclosure base.

### FIELD

The present disclosure relates generally to a thermal runaway containment apparatus for housing a battery.

### BACKGROUND

One type of rechargeable battery is a lithium-ion battery having a multiple-layered structure comprising a positive electrode activated by various mixed oxides or olivines, a negative electrode activated by special carbon, and a separator all immersed in an organic electrolyte. During normal operating conditions, electrical energy is converted to and stored as chemical energy during charging, and stored chemical energy is converted to electrical energy during discharging. More particularly, during charging, lithium in the positive electrode is ionized and moves from layer to layer to the negative electrode; during discharging, the ions move to the positive electrode and return to its original compound. Multiple lithium ion batteries can be mounted on a rack assembly to form a battery pack.

In certain extreme circumstances such as an over-voltage, over-current or over-temperature, a condition known as “self heating” can occur within a lithium ion battery, which can cause the battery to enter a state known as “thermal runaway”. Self-heating is a condition wherein the internal electro-chemical structure of a battery cell causes the temperature therein to increase. Thermal runaway occurs when the internal temperature in the battery increases to a level wherein a chemical reaction occurs and flammable gases are released. If there is sufficient oxygen within the enclosure that houses the battery, the flammable gases will ignite and release a significant amount of energy.

The effects of thermal runaway in a single battery module can be quite dramatic and damaging. When a thermal runaway occurs, small amounts of oxygen is generated and temperatures rises to greater than 800° C. The combination of these events can lead to an internal fire, excessive gassing and, subsequently, a breakdown of an enclosure surrounding the lithium ion cells. The fire rapidly consumes the internally generated oxygen and continues to consume oxygen surrounding the cells. If the cells are sealed in a fire resistant enclosure, the amount of oxygen available to the fire is limited and is quickly consumed and the fire should burn itself out.

However, excessive gases that are generated within the enclosure can cause the internal pressure to increase beyond a safe limit, and may lead to a destructive event such as a rupture in the enclosure and an explosion. Also, the heat caused by internal fire in one battery module can adversely affect nearby battery modules. It is thus desirable to provide a solution to mitigate or prevent destructive events and adverse effects from occurring under these circumstances, and particularly to prevent propagation of the thermal runaway in one battery module to nearby modules in a battery pack.

### SUMMARY

According to one aspect, there is provided a thermal runaway containment apparatus for a battery, comprising: an enclosure base configured to receive a battery therein, an enclosure lid, and a lid constraining structure. The enclosure base has an interconnected floor and side walls, with a top rim defining an open top. The enclosure lid is seatable on the top rim in a seated position that closes the enclosure base. The lid constraining structure is positioned above the lid such that vertical movement of the lid is constrained between the seated position and a maximum partially separated position. When the lid is in the maximum partially separated position, a tortuous flow path into the base is defined, wherein the tortuous flow path allows for venting of pressurized gases out of the enclosure base while impeding inflow of gases at a lower pressure than the pressurized gases into the enclosure base.

The apparatus can further comprise a releasable coupling which physically couples the lid to the base in the seated position. The coupling is configured to release the lid from the base when an internal pressure caused by a thermal runaway event inside the enclosure exceeds a threshold release pressure. The releasable coupling can comprise at least one embossment extending laterally inwards from at least one of the lid vertical sections and frictionally engaging an adjacent lip when the lid is in the seated position. More particularly, the releasable coupling can comprise a row of embossments extending laterally inwards from each vertical section of the lid and frictionally engages each adjacent lip of the base when the lid is in the seated position.

The lid constraining structure can comprise a rack shelf member of a rack assembly in which the enclosure is mounted. The rack shelf member extends above and across at least part of the lid. Alternatively, the lid constraining structure comprises a closed strap that vertically circumscribes the lid and base; the strap has a length that constrains the vertical movement of the lid between the seated and the maximum partially separated positions. Alternatively, the lid constraining structure further comprises means for constraining the lateral movement of the lid, such that the lid can only move substantially in the vertical direction.

The lid can comprises a horizontal section and at least one vertical section extending downwardly from the vertical section. The base can comprise a lip extending upwardly from the base side walls with the rim extending laterally around the lip. The lip and at least one lid vertical section vertically overlap and are laterally spaced from each other in both the lid seated and maximum partially separated positions, thereby defining at least part of the tortuous flow path. The rim can extend laterally outwards around the lip and the at least one lid vertical section is laterally spaced from the rim to define a venting gap; the venting gap defines at least part of the tortuous flow path when the lid is in the maximum partially separated position.

The apparatus can further comprise a gasket extending between the inside surface of the lid horizontal section and the rim such that the gasket establishes a fluid tight seal between the rim and the lid when the lid is in the seated position.

According to another aspect, there is provided a thermal runaway containment apparatus for a lithium ion battery, comprising: at least one enclosure configured to house the battery and a rack assembly in which the enclosure is mounted. At least one of the enclosures comprises: an enclosure base configured to receive a lithium ion battery therein, the base having an interconnected floor and side walls and an open top; an enclosure lid configured to establish a fluid tight seal with the base when the lid is in a seated position on the top of the base, and to define a venting gap between the lid and base when the lid is in a top separated position above the top of the base; and a releasable coupling which couples the lid to the base in the seated position, and is configured to release the lid from the base when an internal pressure caused by a thermal runaway event inside the enclosure exceeds a threshold release pressure. The rack assembly comprises interconnected vertical upright and horizontal shelf members that form at least one slot for housing at least one of the enclosures, wherein the height of the at least one slot is selected such that for at least one of the enclosures mounted in the at least one slot, the vertical movement of the lid is constrained between the seated position and the top separated position. The rack can comprises multiple slots, wherein each slot houses one of the enclosures.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

FIG. 1 is an exploded perspective view of a battery module comprising an enclosure base, a stack of lithium ion energy storage cells, and an enclosure lid, according to one embodiment.

FIGS. 2A and 2B are top perspective and side elevation views of an assembled battery module.

FIGS. 3A and 3B are top perspective and side elevations views of the enclosure base.

FIGS. 4A and B are front perspective and front elevation views of a rack assembly for holding multiple battery modules, wherein the battery modules and part of the rack assembly are not shown in FIG. 4A to better illustrate the internal structure of the rack assembly.

FIGS. 5A and 5B are schematic front sectioned views of the battery module showing the position of the enclosure lid relative to the enclosure base before and during a thermal runaway event.

FIGS. 6A and 6B are side sectioned views of the battery module showing the position of the enclosure lid relative to the enclosure base before and during a thermal runaway event.

### DETAILED DESCRIPTION

Embodiments described herein relate generally to an apparatus for mitigating against undesired effects caused by a thermal runway event in one of more battery modules (hereinafter referred to as a “thermal runaway containment apparatus”) that can house batteries of various types including but not restricted to lithium ion batteries. The embodiments shown in the drawings generally comprise a battery enclosure for enclosing a stack of lithium ion energy cells, wherein the enclosure comprises an enclosure base and an enclosure lid that is releasably coupled to the top of the base. The lid is designed to lift off the base when the pressure inside the enclosure exceeds a selected threshold release pressure, such that a tortuous flow path between the lid and base is formed for venting of pressurized gases inside the enclosure. The threshold release pressure is selected to ensure that the lid remains closed during normal battery operation but lifts off the base when the internal pressure rises as a result of a runaway thermal event, e.g. due to expanding flammable gases formed from self-heating conditions. When the lid lifts off the base, the gases under pressure inside the enclosure will vent out through the tortuous flow path. The tortuous flow path prevents or at least minimizes the ingress of lower pressure air (and attendant oxygen) into the enclosure while the venting of higher pressure gases is occurring, thereby preventing or at least minimizing further combustion of flammable gases inside the enclosure. Therefore, the oxygen available for combustion of the flammable gases during the thermal runaway event should be limited to the oxygen inside the enclosure, and once this oxygen is consumed, combustion should cease and the thermal runaway event should end.

In some embodiments, the lid is physically attached to the base, such as by a pressure fit, and the threshold release pressure is the pressure required to overcome the physical attachment. In other embodiments, the lid is not physically attached to the base, and instead has a weight which is sufficient to keep the lid in a closed sealed position during normal operating conditions, and to allow the lid to separate from the base during a thermal runaway event.

The thermal runaway containment apparatus also includes a lid constraining structure that constrains the vertical movement of the lid relative to the base. More particularly, the lid constraining structure limits the vertical movement of the lid such that the lid can only lift from the base enough to form the tortuous flow path (the maximum lift off height of the lid is herein referred to as the “maximum partially separated position”) and not so much that the entire lid vertically clears the base (i.e. no vertical overlap). In the embodiments shown in the Figures, multiple battery enclosures are mounted inside a rack assembly, and the shelves of the rack assembly immediately above each battery enclosure serve as the lid constraining structure to limit the vertical movement of the lid.

The thermal runaway containment apparatus can also be designed to constrain the lateral movement of the lid when it lifts off the base; this is expected to allow the lid to return back to substantially its original closed position on top of the base when the internal pressure falls. In these embodiments, a vertical overlap between downwardly protruding vertical sections of the lid and an upwardly protruding lip of the base constrain the lateral movement of the lid. The lid vertical sections and the lip are laterally spaced from each other and form part of the tortuous flow path, as well as serves as kind of a backdraft barrier that is expected to contribute to impeding backflow of O₂ into the enclosure. The position of the lid constraining structure is selected to prevent the bottom of the lid from rising above the top of the lip; in other words, there will be a vertical overlap between the lid vertical sections and the lip at all positions between the seated position and the maximum partially separated position. In this sense, the lid constraining structure allows the lid to only partially separate from the base. A venting gap is defined by a lateral spacing between the lid side wall and a rim extending laterally around the top of the lip; the venting gap is closed when the lid rests on the rim and forms a fluid seal, and is open when the lid lifts off from the rim.

In effect, the lid constraining structure in conjunction with the lid act as a one-way pressure release valve that will open when the internal pressure exceeds the threshold release pressure, and will close when the internal pressure falls below the threshold release pressure. In other words, the thermal runaway containment apparatus controls the mixture of flammable gases with air; the battery enclosure and rack assembly work together to control the escape of gases from within the enclosure. The controlled escape minimizes the amount of oxygen ingress into the enclosure, thereby reducing the rate of combustion and preventing the temperature inside the enclosure from rising high enough to significantly affect other batteries in the battery pack.

Instead of the rack shelves illustrated in the Figures, other lid separation constraining structures can be used (not shown). For example, each battery module can be provided with one or more straps which vertically encircle the lid and base with enough play to allow the lid to partially separate from the base. As another example, the enclosure can be provided with one or more bars or plates that extend upwards past the lid and include a horizontal protrusion that limits the vertical movement of the lid.

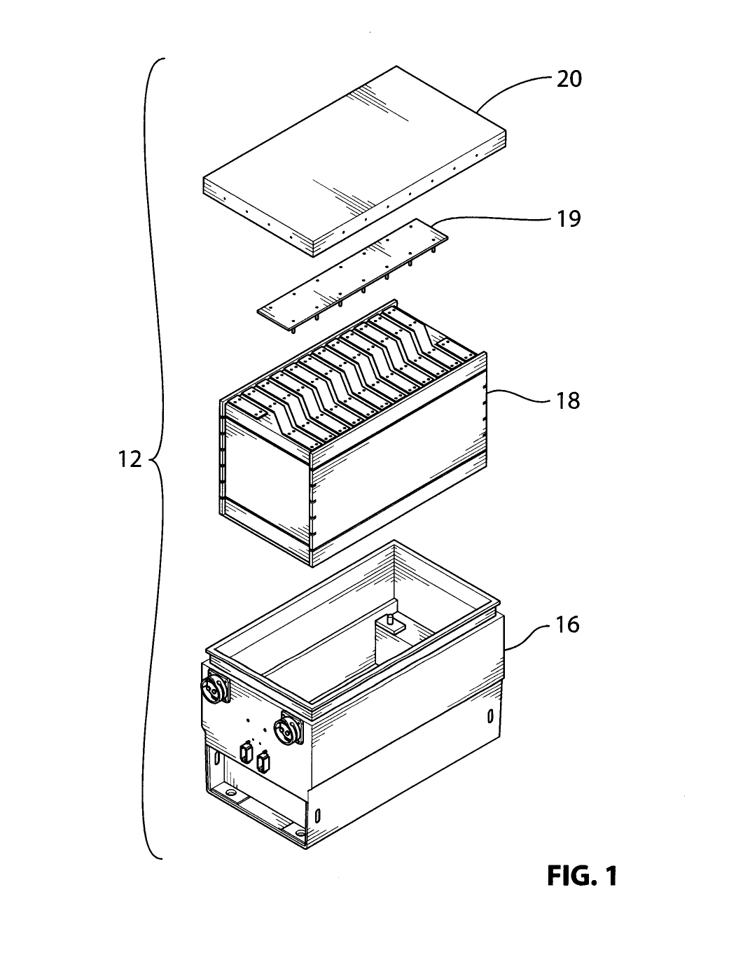

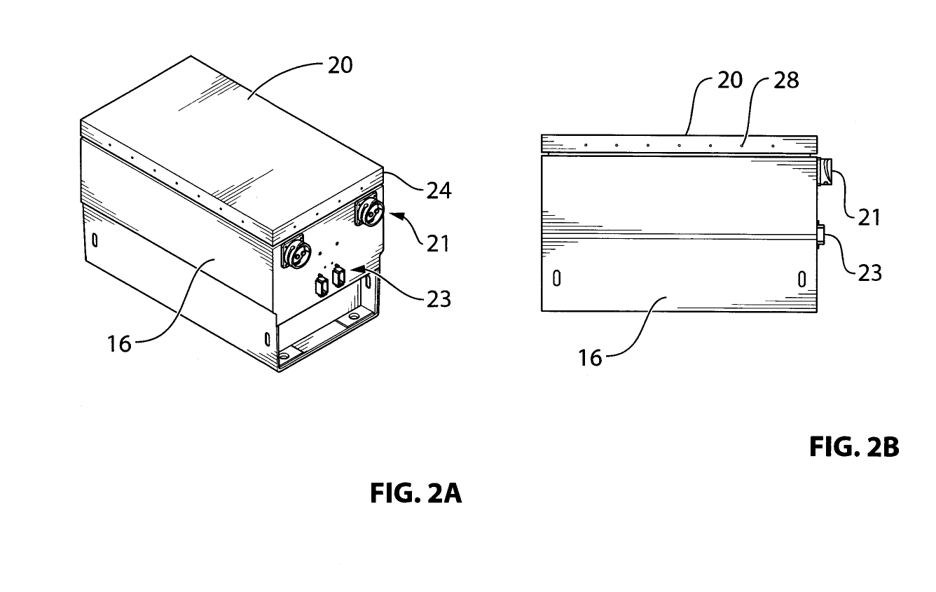

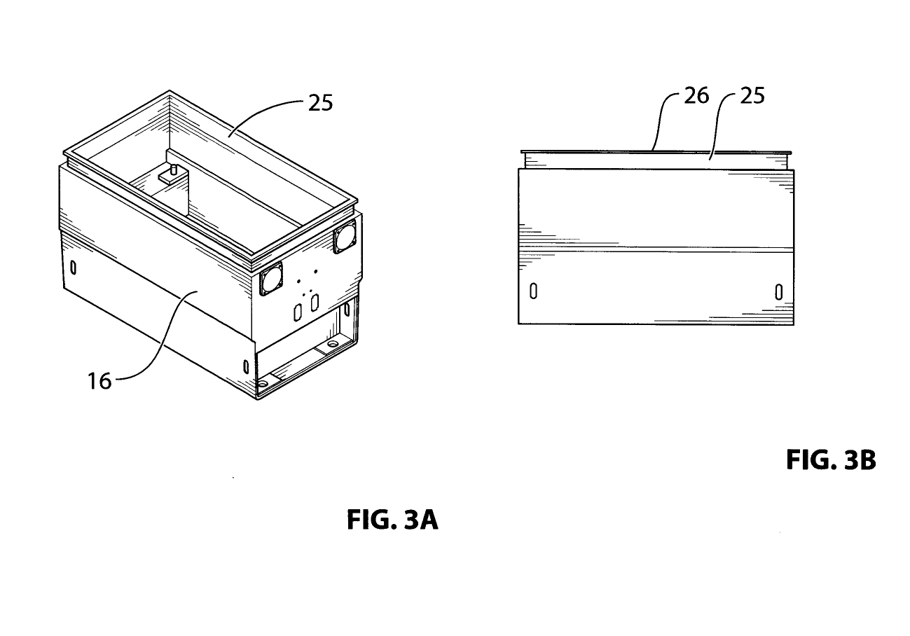

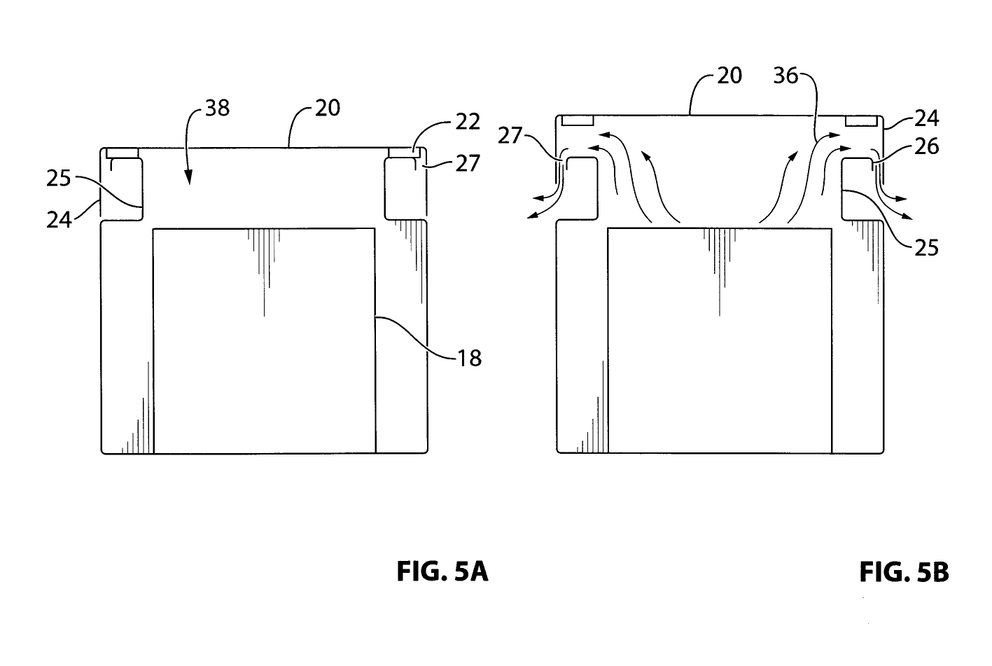

Referring now to FIGS. 1 to 6 and according to a first embodiment, a thermal runaway containment apparatus 10 comprises one or more lithium ion battery modules 12, and a rack assembly 14 in which the battery modules 12 are mounted. As can be seen in FIG. 1, each battery module 12 comprises an enclosure base 16, a stack of lithium ion energy cells 18, battery management system circuitry 19 communicative with the energy cells, and an enclosure lid 20. A gasket 22 (not shown in FIG. 1, but visible in FIG. 5A) lines the inside surface of the lid 20 and ensures a fluid-tight seal when the lid is mounted on the top of the base 16 (“closed position”). The fluid-tight seal is intended to provide an IP67 seal to prevent water from entering the enclosure; such a seal for example, enables the battery module in normal operation to be resistant to water from a water sprinkler or mist. The lid 20 and base 16 are made of a fire resistant material such as aluminum. An external power connector 21 and signal connector 23 for the energy cells 18 is provided on one side of the enclosure base 16.

The lid 20 comprises a rectangular horizontal section and four interconnected vertical sections 24 that extend downwardly from the horizontal section. The base 16 is generally comprised of a rectangular floor and four interconnected side walls that extend upwardly from the floor to form a rectangular box with a top opening.

Referring to FIGS. 5A and 5B, a lip 25 protrudes upwardly from the top edge of each of the four side walls and defines a lateral rim 26 that extends around the perimeter of the box such that the gasket 22 will contact the rim when the lid 20 is seated on the base 16, thereby establishing a fluid-tight seal. Furthermore, the lip 25 is laterally recessed inwards from the side walls such that a lateral space is formed between the lip 25 and the lid vertical sections 24, and a venting gap 27 is formed between the rim 26 and the lid vertical sections 24. As will be discussed in more detail below, this lateral space and venting gap 27 define a tortuous flow path through which gases inside the enclosure can vent when the lid 20 is separated from the base 16. As shown in FIG. 5A, the venting gap 27 is closed by the sealing engagement of the gasket 22 against the rim 26; as shown in FIG. 5B, the venting gap 27 is opened when the lid 20 lifts away from the base 16 thereby separating the gasket 22 from the rim 26.

The lithium ion energy cells 18 are mounted inside the base 16 in a manner known in the art; the dimensions of the base are selected so the cells 18 are located entirely inside the base with some room to spare. The lithium ion energy cells 18 in this embodiment has a potential capacity of 277 Wh. Energy cells capable of this capacity are known in the art, and for example, can be of the type typically used in marine vessels and grid power storage.

Each vertical section 24 of the lip comprises a row of embossments 28 that project inwardly enough that the embossments 26 frictionally engage the surface of the lip 25 when the lid 20 is seated on top of the base 16. The strength of the frictional engagement is selected to match the threshold release pressure, i.e. the frictional engagement strength is overcome when the internal pressure inside the enclosure reaches or exceeds the threshold release pressure. In this embodiment the frictional engagement strength is designed to equal a threshold release pressure of 6 psi.

Although embossments 28 are shown in these Figures, other means to physically attach the lid 20 to base 16 can be used, such as a spring, an adhesive or a frangible connector (not shown); like the embossments 28, the other physical attachment means are designed to detach when the internal pressure reaches or exceeds the threshold release pressure.

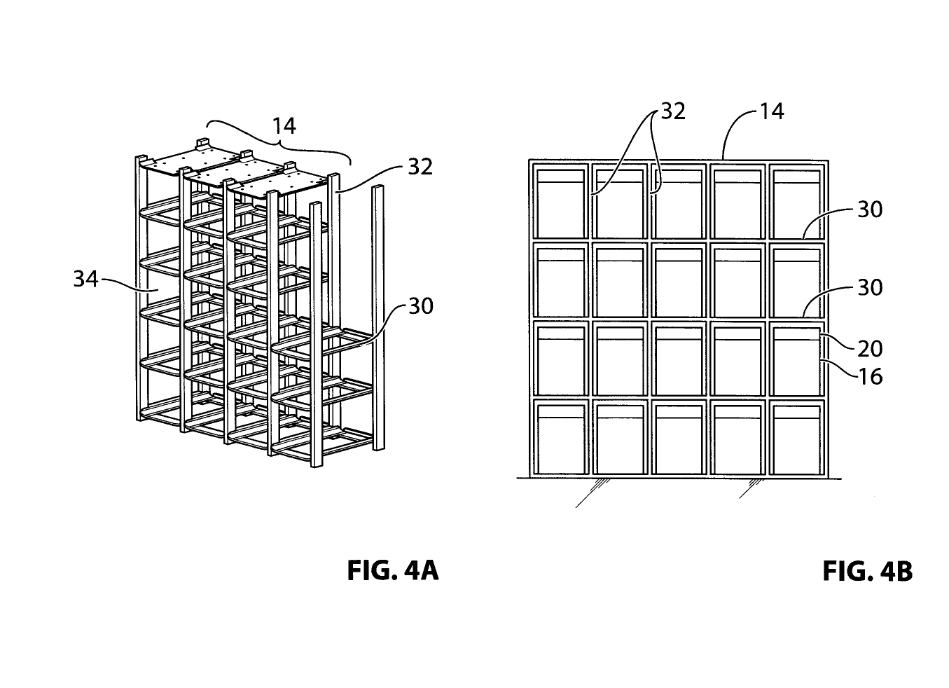

Referring now to FIGS. 4A and 4B, the rack assembly 14 comprises a number of interconnected shelf members 30 and uprights members 32 that define slots 34 for housing battery modules 12. The battery modules 12 can be connected in series, parallel or a combination of series and parallel connections. In this embodiment, there are twenty slots 34 arranged in a four row by five column matrix. However, the rack assembly 14 can have a different number of slots that are arranged in a different matrix configuration. The dimensions of each slot 34 are selected to fit a battery module 12, and allow enough vertical clearance for the lid 20 to partially separate from the base 16. “Partially separate” in this embodiment means that the lid 20 can lift vertically off the lip's rim 26, but the bottom edge of the lid vertical sections 24 does not rise higher than the top edge of the rim 26; “maximum partially separated position” means the maximum vertical distance the lid 20 can lift off the base 16, as constrained by the top of the slot 34. In this embodiment, each slot has a 388 mm wide by 415 mm high dimension, and a closed enclosure has a height of 378 mm from the bottom of the base 16 to the top of the lid 20. The lid vertical sections are 50 mm. This means that there is only 37 mm of vertical clearance for the lid 20 to lift off the base 16, and since the lid vertical sections are 50 mm, that there will be a 13 mm vertical overlap with the adjacent lip 25. Therefore, the lid 20 is vertically and laterally constrained by the rack assembly 14 and the lip 25, such that a runaway thermal event will cause the lid 20 to rise to the top separated position and return back substantially to its original seated position. The venting area will be between 1500 and 3000 mm² depending on how high the lid 20 lifts off the base 16. The lip 25 will also serve as a guide to reduce the tendency of the lid 20 to lift off the base at an angle, thereby affecting the venting gap size.

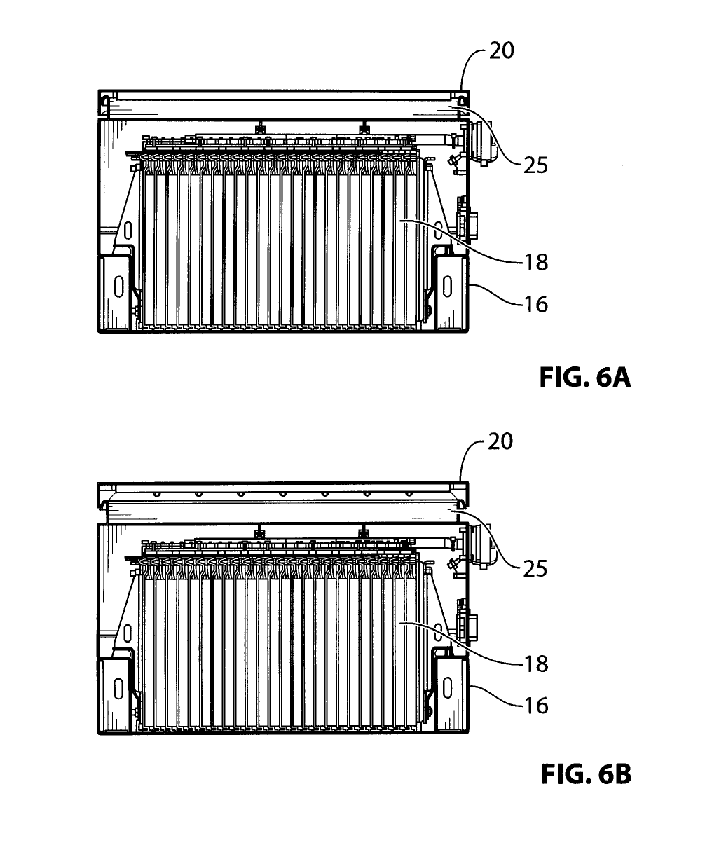

As can be seen in FIGS. 5A and 5B and FIGS. 6A and 6B, the vertical overlap of the lid vertical sections 24 and the lip 25 in combination of the rim 26 and venting gap 27 define a tortuous flowpath for the venting of pressurized flammable gases 36 from the enclosure. This tortuous flowpath serves as a backdraft barrier, and is theorized to contribute to the prevention or impediment of oxygen ingress when the venting gap 27 is open and pressurized gases are being vented, thereby limiting the extent to which the flammable gases can ignite within the enclosure. The relatively small size of the venting gap 27 and its consistent size around the lid 20 and base 16 are also expected to contribute the backdraft barrier. The heat generated by the flammable gases should therefore be substantially lower (<400° C. inside the module), and low enough (<100° C. at adjacent modules) that adjacent batteries will not heat up enough to trigger thermal events therein.

In operation, a thermal runaway event results in the release of the flammable gases 36, which expand into the empty spaces 38 within the battery enclosure. When these gases 36 combust with oxygen inside the enclosure, the pressure inside the enclosure will increase. Once the internal pressure increases beyond the threshold release pressure, the frictional engagement provided by the embossments 28 is overcome, and the internal pressure causes the lid 20 to lift vertically off the rim 26. When this happens, the gasket 22 separates from the rim 26 and the venting gap 27 is now open, i.e. in fluid communication with the inside of the enclosure. Since little or no fresh oxygen is expected to ingress while the flammable gases 36 are venting, combustion is expected to stop and the thermal runaway event is expected to end shortly after venting occurs. Once enough pressurized gases and combustion products have vented, the internal pressure will fall to ambient pressure and the weight of the lid 20 should cause the lid 20 to fall back into place thereby resealing the enclosure. In some instances, the force of the lid separation may cause the lid 20 to embed in the rack shelf members 30; however, it is expected that the controlled venting provided by the tortuous flow path will cause combustion to stop and the thermal runaway event to end notwithstanding that the venting gap 27 remains open.

Instead of the tortuous flow path being provided by the vertically overlapping lid and lip 24, 25, rim 26, and venting gap 26, the tortuous flow path can be provided by another structure (not shown). For example, such a tortuous flow path can be incorporated entirely into the lid structure, or entirely into the lip/rim structure (not shown).

The terminology used herein is for the purpose of describing particular embodiments only and is not intended to be limiting. Accordingly, as used herein, the singular forms “a”, “an” and “the” are intended to include the plural forms as well, unless the context clearly indicates otherwise. It will be further understood that the terms “comprises” and “comprising,” when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections.

It is contemplated that any part of any aspect or embodiment discussed in this specification can be implemented or combined with any part of any other aspect or embodiment discussed in this specification.

The scope of the claims should not be limited by the preferred embodiments set forth in the examples, but should be given the broadest interpretation consistent with the description as a whole.

1. A thermal runaway containment apparatus for a battery, comprising:
(a) an enclosure base configured to receive a battery therein, the base having an interconnected floor and side walls, with a top rim defining an open top;
(b) an enclosure lid seatable on the top rim in a seated position that closes the enclosure base;
(c) a lid constraining structure positioned above the lid such that vertical movement of the lid is constrained between the seated position and a maximum partially separated position; and
(d) when the lid is in the maximum partially separated position, a tortuous flow path into the base, the tortuous flow path allowing for venting of pressurized gases out of the enclosure base while impeding inflow of gases at a lower pressure than the pressurized gases into the enclosure base.

2. The apparatus of claim 1 further comprising a releasable coupling which physically couples the lid to the base in the seated position, and is configured to release the lid from the base when an internal pressure caused by a thermal runaway event inside the enclosure exceeds a threshold release pressure.

3. The apparatus of claim 1 wherein the lid constraining structure comprises a rack shelf member of a rack assembly in which the enclosure is mounted, the rack shelf member extending above and across at least part of the lid.

4. The apparatus of claim 1 wherein the lid constraining structure comprises a closed strap that vertically circumscribes the lid and base, the strap having a length that constrains the vertical movement of the lid between the seated and the maximum partially separated positions.

5. The apparatus of claim 1 wherein the lid constraining structure further comprises means for constraining the lateral movement of the lid, such that the lid can only move substantially in the vertical direction.

6. The apparatus of claim 1 wherein the lid comprises a horizontal section and at least one vertical section extending downwardly from the vertical section, and the base comprises a lip extending upwardly from the base side walls with the rim extending laterally around the lip, and wherein the lip and at least one lid vertical section vertically overlap and are laterally spaced from each other in both the lid seated and maximum partially separated positions, thereby defining at least part of the tortuous flow path.

7. The apparatus of claim 6 wherein the rim extends laterally outwards around the lip and the at least one lid vertical section is laterally spaced from the rim to define a venting gap, and wherein the venting gap defines at least part of the tortuous flow path when the lid is in the maximum partially separated position.

8. The apparatus of claim 7 further comprising a gasket between the inside surface of the lid horizontal section and the rim such that the gasket establishes a fluid tight seal between the rim and the lid when the lid is in the seated position.

9. The apparatus of claim 2 wherein the releasable coupling comprises at least one embossment extending laterally inwards from at least one of the lid vertical sections and frictionally engages an adjacent lip when the lid is in the seated position.

10. An apparatus as claimed in claim 9 wherein the releasable coupling comprises a row of embossments extending laterally inwards from each vertical section of the lid and frictionally engages each adjacent lip of the base when the lid is in the seated position.

11. A thermal runaway containment apparatus for a lithium ion battery, comprising:
(a) at least one enclosure, comprising:
an enclosure base configured to receive a lithium ion battery therein, the base having an interconnected floor and side walls and an open top;
(ii) an enclosure lid configured to establish a fluid tight seal with the base when the lid is in a seated position on the top of the base, and to define a venting gap between the lid and base when the lid is in a top separated position above the top of the base; and
(iii) a releasable coupling which couples the lid to the base in the seated position, and is configured to release the lid from the base when an internal pressure caused by a thermal runaway event inside the enclosure exceeds a threshold release pressure; and
(b) a rack assembly comprising interconnected vertical upright and horizontal shelf members that form at least one slot for housing at least one of the enclosures, wherein the height of the at least one slot is selected such that for at least one of the enclosures mounted in the at least one slot, the vertical movement of the lid is constrained between the seated position and the top separated position.

12. The apparatus of claim 11 wherein the rack assembly comprises multiple slots, and each slot houses one of the enclosures.

13. The apparatus of claim 11 wherein for the at least one enclosure, the base further comprises a lip extending upwards from a top of the side walls, and the lip comprises a rim that extends horizontally around the periphery of the side wall; and wherein the lid comprises a horizontal section and vertical sections extending downwards from the horizontal section, such that there is a vertical overlap between the vertical sections of the lip and the lip of the base when the lid is in each of the seated and top separated positions.

14. The apparatus of claim 13 wherein at least one of the vertical sections of the lip is laterally spaced from an adjacent lip of the base, thereby defining a venting gap, and wherein the horizontal section of the lid is seated on the rim when the lid is in the seated position thereby closing the venting gap, and wherein the horizontal section of the lid is separated from the rim when the lid is in the separated position thereby opening the venting gap.

15. The apparatus of claim 14 further comprising a gasket attached to the inside surface of the horizontal section of the rim such that the gasket establishes a fluid tight seal between the rim and the lid when the lid is in the seated position.

16. The apparatus of claim 11 wherein the releasable coupling comprises at least one embossment extending laterally inwards from at least one of the rims and frictionally engages an adjacent lip of the base when the lid is in the seated position.

17. The apparatus of claim 16 wherein the releasable coupling comprises a row of embossments extending laterally inwards from each vertical section of the lid and frictionally engaging each adjacent lip of the base when the lid is in the seated position.
